(19) United States
(12) Patent Application Publication
(10) Pub. No.: US 2025/0187326 A1
(43) Pub. Date: Jun. 12, 2025

(54) SUBSTRATE CART AND RELATED SYSTEMS

(71) Applicant: Shaun Brian Arthur Marrison, Roselle, IL (US)

(72) Inventor: Shaun Brian Arthur Marrison, Roselle, IL (US)

(21) Appl. No.: 18/932,297

(22) Filed: Oct. 30, 2024

Related U.S. Application Data
(60) Provisional application No. 63/595,236, filed on Nov. 1, 2023.

(51) Int. Cl. B41F 15/18

(52) U.S. Cl. CPC B41F 15/18

(57) ABSTRACT

The present invention is generally directed to a substrate cart and related systems. The cart includes a registration system for use with the related systems to guarantee the cart and substrate is in proper alignment for a manufacturing or production process step. The cart comprises removably coupled adaptors to support multiple manufacturing processes. The system comprises docking features configured to align the cart registration consistently with each manufacturing process station.

### CROSS-REFERENCE TO RELATED APPLICATION

The present application claims priority to and the benefit of U.S. Provisional Application No. 63/595,236, filed Nov. 1, 2023, the contents of which are incorporated herein by reference and made a part hereof.

### BACKGROUND OF THE INVENTION

The present invention generally relates to the field of substrate carts used in factory manufacturing and process automation. More particularly the invention relates to an automated substrate cart and system configured for consistent station alignment and registration for repeatable processes.

One of the keys to efficient manufacturing and production across a wide variety of industries is consistency and accuracy across a processes. The standard operating procedure across an assembly line breaks down large processes into smaller tasks with fixtures at each step. Fixtures allow for each step to be completed the same way for every product that comes through across that particular step. In designing a fixture, the typical engineer creates registration features to ensure proper alignment of the product or substrate in the fixture such that a process can be performed the same way every time and each resulting product is identical to the previous resulting product. If there were no alignment or registration features in the fixture, the resulting product would be inconsistent with the prior product leading to variability in the end products. Ultimately this could lead to rejected products and wasted time on the assembly line.

In the context of a digital printing and decoration operation or process, a key issue is printing multiple layers at different station and ensuring that each garment substrate is aligned the appropriate way for each different machine processing step. If the garment substrate is misaligned, the print will be a defect and the substrate has to be discarded. This leads to wasted machine process time and materials.

The present invention seeks to remedy some of the deficiencies across registration and alignment features in existing process stations by providing a substrate cart configured to register and align at various process stations in manufacturing and production consistently and accurately at each step.

### SUMMARY OF THE INVENTION

The present invention is generally directed to a substrate cart and related systems. The substrate cart includes a registration system for use with the related systems to guarantee the substrate cart and substrate is in proper alignment for a manufacturing or production process step. The substrate cart may be configured to accommodate linear rail systems, mechanisms, electronics, motion systems, adaptors, and accessories and apply a variety of delivery systems for a variety of applications. One of skill in the art would recognize that the term manufacturing process may include any type of process step in product production, such as, but not limited to, a decorating process, an assembly process, cutting processes, and additive or subtractive processes.

Example applications include but are not limited to the following textile decoration applications: direct to garment (DTG), direct to film (DTF), foil, diamante/rhinestone, high build 3D, roll to roll, vacuumable substrates, 3D printing, engraving, laser burning or etching, ceramic printing, XY cutting. One of skill in the art will see the benefits of the substrate cart and system outside of the textile industry where multiple process steps are taken at a variety of stations, such as the food industry or any other industry that utilizes an XYZ process step application.

In one aspect the system comprises a substrate cart having a base frame, at least one adaptor position and locator feature disposed in the base frame, and a registration system coupled to or integral to the base frame. In an example aspect, the base frame may have a front member, a rear member, and a pair of side members forming a rectangular frame. In this aspect, a first registration system may be coupled to inner portion of the front member and a second registration system may be coupled to the inner portion of the rear member to ensure the substrate cart has aligned and registered to the front and rear portions of the substrate cart are properly aligned for the upcoming manufacturing process. Additionally in this aspect, the base frame may include inner support members spanning the interior of the frame providing additional support or additional adaptor position and locator features. One of skill in the art may find it advantageous for particular applications to provide outer support members having adaptor and locator features extending from the outside of the base frame as well.

In yet another aspect, the substrate cart may comprise a unique identifier such that the substrate cart can be manually, remotely, or automatically identified across a manufacturing process.

In another aspect of substrate cart, the substrate cart is configured with rapid interchangeability of non-permanent components removably coupled to the adaptor position and locator features of the substrate cart. These components may include, but are not limited to support booms, pallets, protective skids, or substrate cart wheels.

In other aspects, an interchangeable component may comprise a system to couple multiple substrate carts together. This system may include but is not limited to articulating links, magnets, electro-magnets, ball and joint systems, cylindrical joint systems, or latch and hook type systems.

In additional aspects, the substrate cart registration system comprises a support spine, at least one transport wheel, a registration alignment feature set, hold down blocks configured to couple to a registration dock or manufacturing process station, and a registration guide. In some aspects the registration guide is an “L-flat” member extending normal to the support spine configured to contact a registration sphere of a registration dock or manufacturing process station. In some aspects, the registration guide and spine comprise additional force, proximity, or optical sensors configured to notify the registration dock, manufacturing process station, or cloud automation system of substrate cart alignment. In some aspects the at least one transport wheel is automated with a motor and can be controlled locally, by the manufacturing process station, or remotely by a cloud based automation system configured to monitor all substrate carts.

In yet another aspect, the system comprises a registration dock. One of skill in the art would recognize that the registration dock may be a stand-alone dock, or features integrated into a manufacturing process station. The registration dock may comprise a dock body having rails configured to accommodate transport wheels of the substrate cart registration system allowing the substrate cart to traverse the Y-axis of the registration dock, registration spheres configured to make X-axis and Y-axis contact with the registration guide and spine, hold down features configured to couple to the substrate cart hold down blocks, and a nudging system to help align the substrate cart in the X-axis direction. In some aspects the registration dock may comprise registration spheres proximal the front and rear ends of the registration dock to align with the front and rear registration guides of the substrate cart. In some aspects, the registration dock or sphere comprises additional force, proximity, or optical sensors configured to notify the registration dock, manufacturing process station, or cloud automation system of substrate cart alignment.

In yet another aspect, the registration dock or manufacturing process station may comprise a unique identifier such that the substrate cart can be manually, remotely, or automatically identified across a manufacturing process.

In an additional aspect, the registration dock may further comprise a height adjustment system configured to lower and raise the registration dock along a Z-Axis. In some aspects the adjustment system is manual, while in other aspects, the Z-Axis adjustment is motorized and can be automated depending on a preprogrammed manufacturing process station or remotely controlled through a cloud automation system.

In one aspect of the system, a method of engaging the substrate cart with the registration docking station may include the steps aligning the registration transport wheels to the registration docking rails, rolling the substrate cart onto the registration docking rails until the front member until the registration spine makes contact with a first registration sphere in the Y-Axis and the registration guide makes contact with the first registration sphere in the X-Axis direction and the second registration guide makes contact with the second registration sphere in the X-Axis direction and the second registration spine in the Y-Axis direction, activating the hold down blocks and hold down members to engage and lock the substrate cart into place.

In another of the system, a method of engaging the substrate cart with the registration docking station may include the steps aligning the registration transport wheels to the registration docking rail, rolling the substrate cart onto the registration docking rails until the front member contacts a first nudge locator, activating the first nudge locator to nudge the front member such the registration spine makes contact with the first registration sphere, activating a second nudge locator to nudge the registration guide and substrate cart in a horizontal direction such the registration guide makes contact with the first registration sphere, activating the third nudge locator to nudge the second registration guide and substrate cart in a horizontal direction such the second registration guide makes contact with the second registration sphere, activating the hold down blocks and hold down members to engage and lock the substrate cart into place.

In additional aspect of the system, sensors from either the substrate cart or registration dock sense when the registration sphere is in contact with both the spine and the registration guide and activate the hold down blocks and hold down members to engage and lock the substrate cart.

One of skill in the art would recognize that the registration dock may comprise multiple registration spheres and multiple nudging stations and the registration systems may comprise additional registration guides depending on the application.

In another aspect, the system comprises a backend cloud system comprising a database containing a manufacturing process station XYZ positional layout, the system communicatively coupled with each manufacturing process station and a plurality of substrate carts and registration docks. In this aspect, each substrate cart additionally communicates its position through a means of wireless communication to the backend cloud system and the backend cloud system is configured to send station instructions and directional instructions to the substrate cart to control the transport wheels or skid wheels to direct the substrate cart to the next station.

In the context of the textile decoration industry, one of skill in the art may use the substrate cart for consistency in alignment for multiple layers of decoration. Non-limiting examples of decoration delivery systems such as: UV ink, latex ink, solvent ink, textile ink, plastic (hot), 3D materials, clay, concrete, glue/adhesive, sealant, solder, or laser. One of skill in the art would recognize that the terms textile and garment may be used interchangeably throughout this specification. In this context, the substrate is a textile or garment, the substrate cart may be adapted with a boom configured to secure a pallet, and the pallet configured to secure the textile. The substrate cart is coupled to a registration dock and further coupled to a manufacturing process station for decoration.

In the context of the culinary or food processing industry, the substrate may be a dough, each substrate cart may be configured with a support boom, and an industrial bread pan. Each substrate cart may be processed aligned and moved through a backing station with rails leading in and out of an oven, and post baking, may be moved to a cutting station to cut individual buns or rolls. The aligned substrate carts allow for the buns or rolls to be cut consistently in each operation.

One of skill in the art will be able to adapt the substrate cart for multiple industrial applications that need consistency in alignment across processes.

### BRIEF DESCRIPTION OF THE DRAWINGS

In the accompanying figures, like elements are identified by like reference numerals among the several preferred embodiments of the present invention.

FIG. 1 illustrates a perspective view an example substrate cart and base frame assembly.

FIG. 2 illustrates a rear perspective view of an example substrate cart showing a unique identifier.

FIGS. 3-4 illustrate perspective views of alternative substrate cart and base frame assemblies.

FIGS. 5-7 illustrate perspective views of alternative substrate cart and base frame assemblies configured for embroidery applications.

FIGS. 8-9 illustrate perspective views of alternative substrate cart and base frame assemblies configured for long pants decoration.

FIG. 10 illustrates perspective views of alternative substrate cart and base frame assemblies configured for multiple applications.

FIGS. 11-12 illustrate perspective views of the base frame adaptor features.

FIGS. 13-14 illustrate perspective views of a base frame connector adaptor.

FIGS. 15-17 illustrate perspective views of additional base frame adaptors.

FIGS. 18-19 illustrate perspective views of the registration system.

FIGS. 20-23 illustrate perspective views of the registration dock system.

FIGS. 24-25 illustrate perspective views of the substrate cart assembly used in an example decorating system.

FIGS. 25-28 illustrate perspective views of the substrate cart assembly used in an additional example decorating system.

FIGS. 29-33 illustrate perspective views of a substrate cart height adjustment system.

FIGS. 34-37 illustrate perspective views of the substrate cart assembly used in additional example decorating systems.

FIGS. 38-42 illustrate perspective views of the substrate cart assembly used as a vacuum table.

FIGS. 43-46 illustrate perspective views of the substrate cart assembly used as used in a direct to film print transfer process.

Other aspects and advantages of the present invention will become apparent upon consideration of the following detailed description, wherein similar structures have similar reference numerals.

### DETAILED DESCRIPTION OF THE PREFERRED EMBODIMENTS

The foregoing and other features and advantages of the invention will become more apparent from the following detailed description of an exemplary embodiment, read in conjunction with the accompanying drawings. The detailed description and drawings are merely illustrative of the invention rather than limiting, the scope of the invention being defined by the appended claims and equivalents thereof.

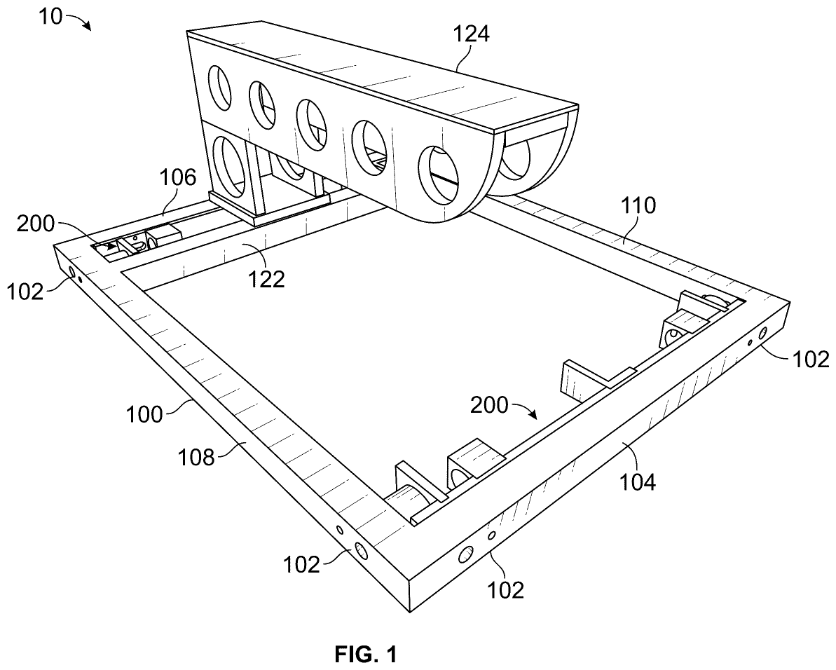

FIG. 1 represents a perspective view of the substrate cart 10. The substrate cart 10 comprises a base frame 100, an adaptor position and locator feature 102 disposed in the base frame 100, and a registration system 200 coupled to the base frame 100.

In one aspect, the base frame 100 is a rigid member. One of skill in the art would appreciate that the base frame 100 can be made of any rigid material including but not limited to: aluminum, bright steel, carbon-mild steel, wood, plastic, fiberglass, acrylic, carbon fiber, or any other rigid composite.

In another aspect as shown in FIG. 1 the base frame 100 comprises a rectangular shape having a front member 104, a rear member 106, a first side member 108, a second side member 110 and an inner member 112. Further, the base frame 100 comprises a first opening 114 disposed in the base frame 100 bound by inner surfaces of the front member 104, the first side member 108, the second side member 110 and the inner member 112 and a second opening 116 disposed in the base frame 100 bound by inner surfaces of the rear member 106, the first side member 108, the second side member 110 and the inner member 112. A first registration system 200 may be coupled to the inner surface of the front member 104, and a second registration system 200 may be coupled to the inner surface of the rear member 106. As shown in FIG. 1, the adaptor position and locator feature 102, may be disposed in the outer surfaces of the front member 104, rear member 106, first side member 108, or second side member 110. In some aspects an adaptor position and locator feature 102 is disposed on all members proximal the intersecting corners of the front member 104, rear member 106, first side member 108, or second side member 110. One of skill in the art would appreciate that the base frame 102 is not limited to a rectangular shape and may have a different perimeter shape depending on the decoration or XYZ application.

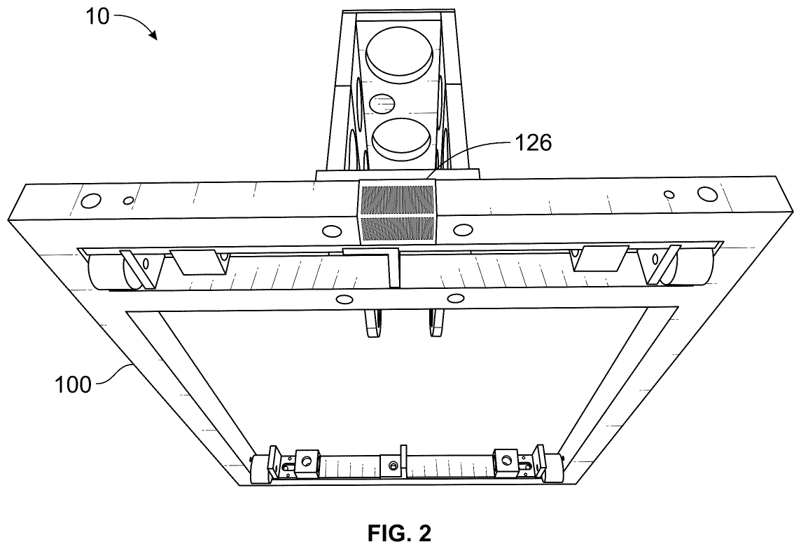

In some aspects of the substrate cart 10, as shown in FIG. 2 the base frame 100 may also comprise a unique identifier 126 integral with or coupled to the base frame 100. The unique identifier 126 may include, but is not limited to, a sticker, a tag, an etching in the form of a serial number, barcode or QR code, or an RFID or NFC tag, or wireless communication device such as but not limited to cellular, Bluetooth, Wi-Fi, Lora, or Ultra Wide Band (UWB) transmitter. The unique identifier 126 may be correlated with a tracking or information database stored locally or on a cloud computing system such that it can be identified throughout the factory or particular manufacturing process.

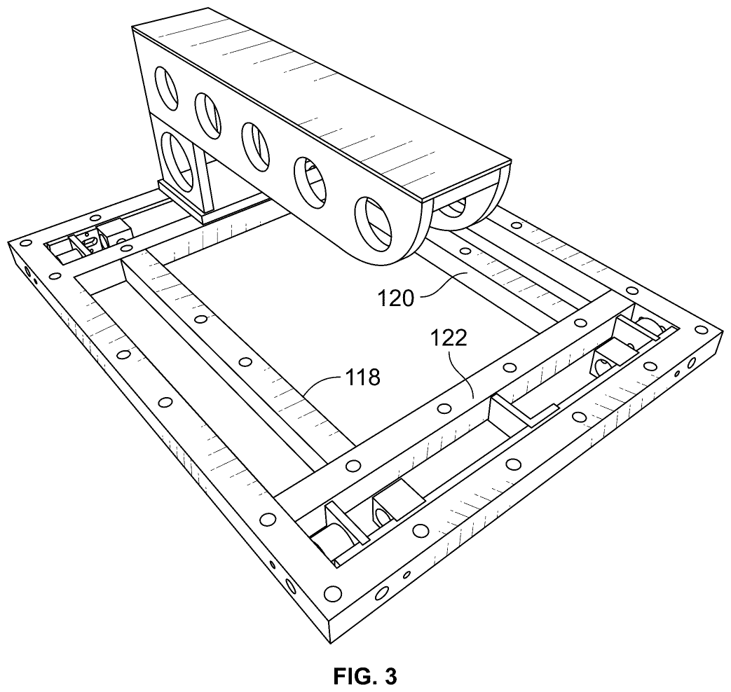

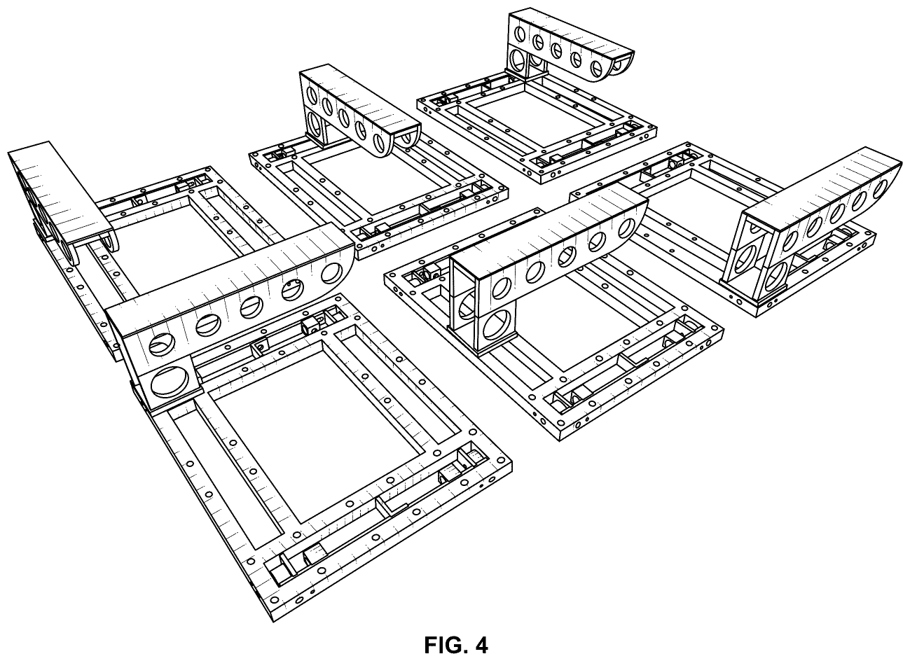

In other aspects of the substrate cart 10, additional inner members 118, 120, 122 as shown in FIG. 3 may be added for additional support or additional feature adaptation. For example, boom 124, which is coupled to the rear member 106 and inner member 112 may be coupled to either side member 108, 110 or front member 104 and inner members 118, 120, 122 as shown in FIG. 4. The boom 124 or additional feature adaptations may be coupled through standard fasteners such as but not limited to leveling bolts.

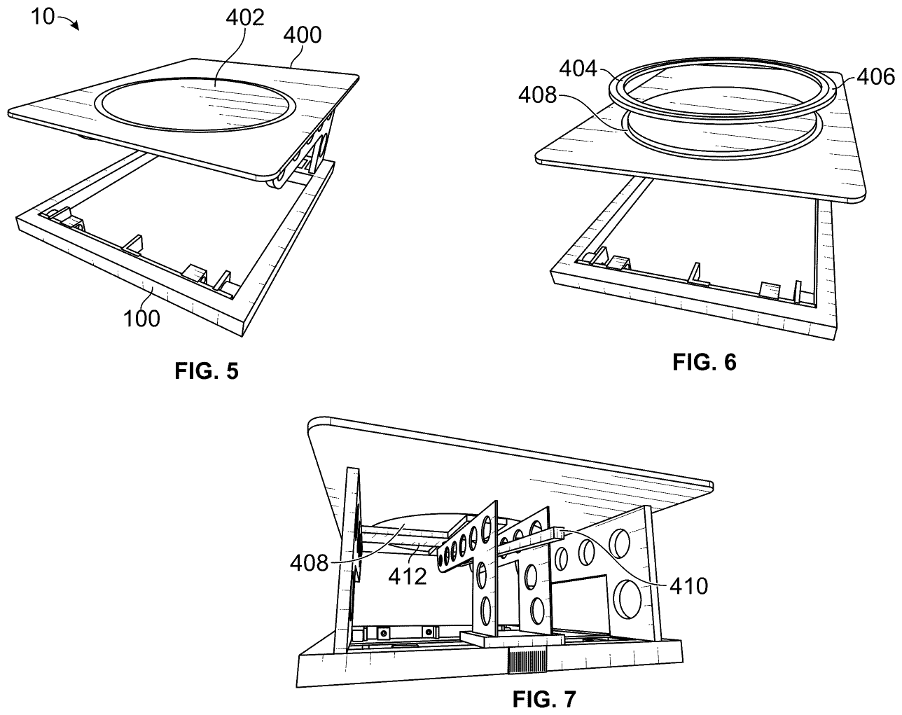

In further examples in the context of the textile industry, as shown in FIGS. 5-7, the substrate cart 10 and base frame 100 may be adapted for use an embroidery pallet 400. In this example, a plurality of booms (or at least one boom) 124 is couple to the base frame 100 to support the embroidery pallet 400. The embroidery pallet 400 comprises a support pad 402 configured to support the garment or textile during the embellishment process, an inner hoop 404 configured to keep the garment or textile tensioned for attachment to an embroidery machine, an outer hoop 406 coupled to the inner hoop 404 configured to tension the garment or textile for the embroidery application, a plunger 408 which functions as an inner pad to eject the support pad 402 such that the outer hoop 406 can be affixed, an ejector level 410 configured to activate the plunger 408 and a pivot mechanism 412 including linkages to ensure the plunger 408 ejects in a smooth and aligned matter. In this application, as further detailed below, the substrate cart 10 would align with an embroidery machine through the registration systems 200 and the attached garment or textile would receive embroidery.

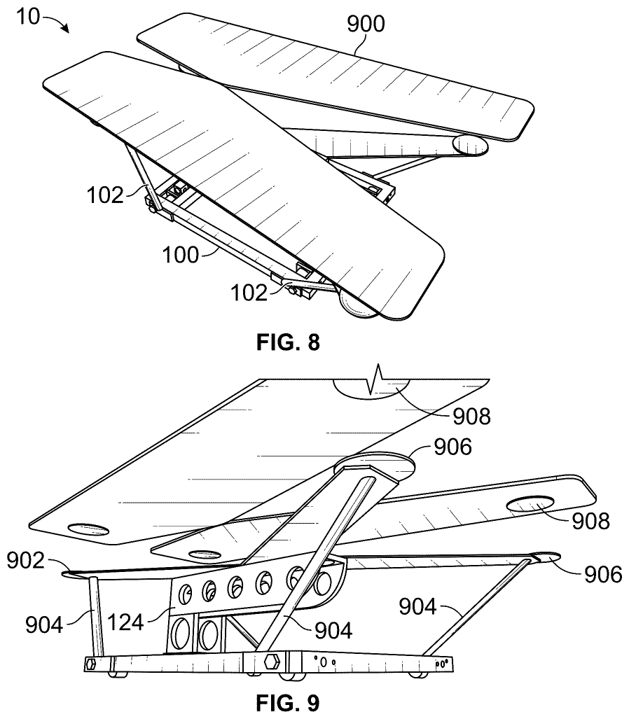

In additional examples, as shown in FIGS. 8 and 9, the substrate cart 10 and base frame 100 may be adapted for a long pants pallet 900. In this example, a boom 124 is coupled to the base frame 100 to support the long pants pallet fixture 902. The long pants pallet fixture 902 may comprise a plurality of long pants pallet fixture support members 904 coupled to the adaptor position and locator features 102, further coupled to a long pants pallet fixture support and location member 906. The long pants pallet 900 may comprise hold down locators (in some cases magnetic) 908 configured to align to and couple to the long pants pallet fixture support and location member 906. In this application, as further detailed below, the substrate cart 10 would align with an application machine through the registration systems 200 and the attached long pants would receive its decoration application.

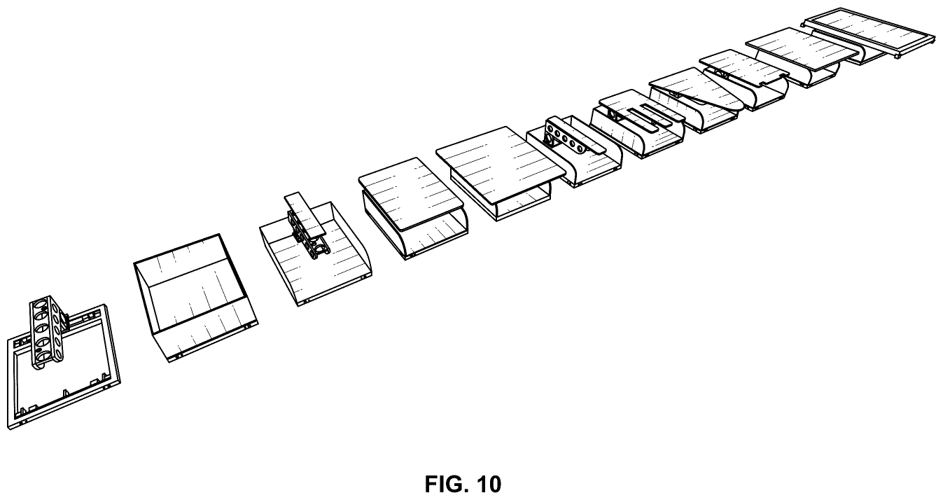

As shown in FIG. 10 one of skill in the art can adapt the substrate cart 10 to multiple applications. FIG. 10 shows a number of adapted substrate carts 10 configured for traditional screen printing. Each substrate cart is precisely calibrated with the registration system 200. To engage with each machine in the screen printing process to ensure accurate and consistent alignment for each textile or garment.

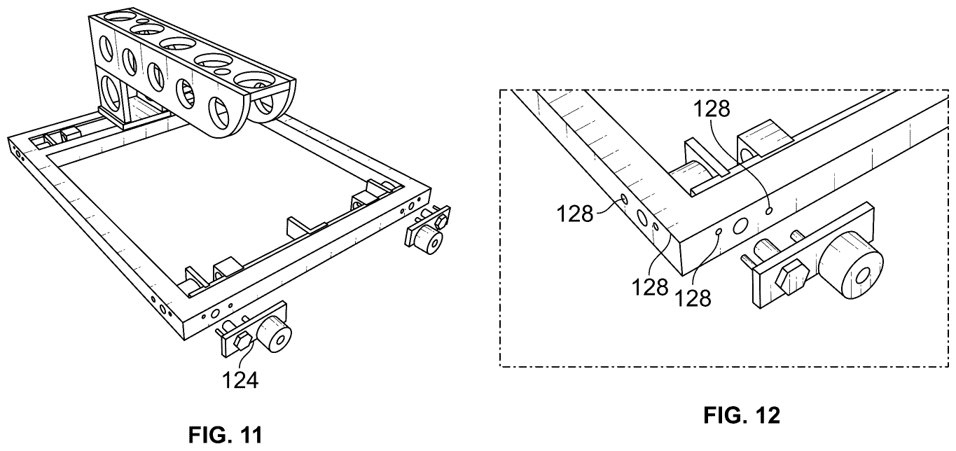

In yet another aspect, adaptor position and locator features 102 or plurality thereof may comprise openings for adaptors to attach or couple to the base frame 100. These openings may be configured for a fastener to hold an adaptor, like the boom 124 or add-on mechanism such as a frame connector 300 in the proper orientation. As shown in FIGS. 11-12 in some aspects, the openings arc paired with a locator pin feature 128 adjacent to the adaptor position and locator features 102.

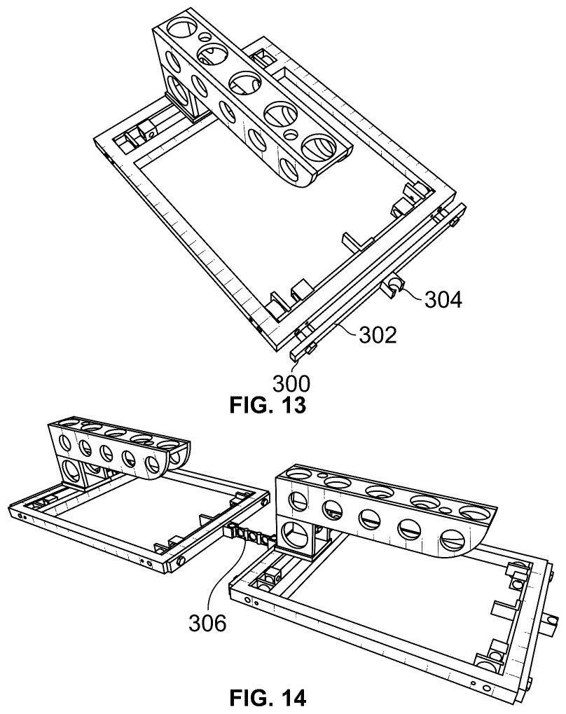

FIGS. 13-14 show a frame connector 300 add-on mechanism as utilized in certain aspects of the invention. As shown in the frame connector 300 is coupled to the base frame 100 through the adaptor position and locator features 102. The frame connector 300 comprises a spine 302 that affixes to the front member 104 or rear member 106 and a coupling mechanism 304 configured to couple to another base frame 100 of a separate substrate cart 10 or additional external entity. In some aspects as shown in FIG. 14 the coupling mechanism 304 is attached to an articulating linkage 306. One of skill in the art would recognize that the coupling mechanism can be any common mechanical coupling mechanism including but not limited to fasteners, ball or cylindrical joints, or magnets.

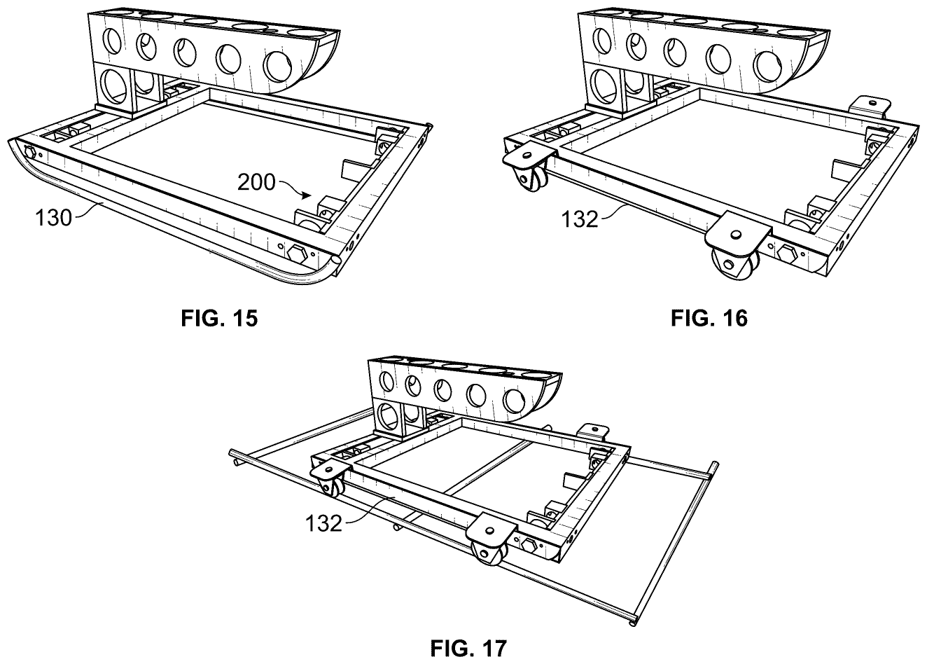

Other example adaptors for the substrate cart 10 are shown in FIGS. 15-17. FIG. 15 shows protective skids 130 coupled to the base frame 100 configured to protrude below the registration system 200 and protect the components thereof in transfer. FIGS. 16-17 show the addition of base frame transport wheel adaptors 132 coupled to the base frame 100 configured to protrude below the registration system 200 and protect the components thereof in transfer. The base frame transport wheel adaptors 132 may be configured with standard wheels or grooved wheels configured to travel along cable guides. In some instances the wheels may be configured with to swivel in order to follow a curved path or curved cable guide. In other instances a manual or automated braking system may be added frame transport wheel adaptors 132 that may be controlled locally or remotely through a wireless control system.

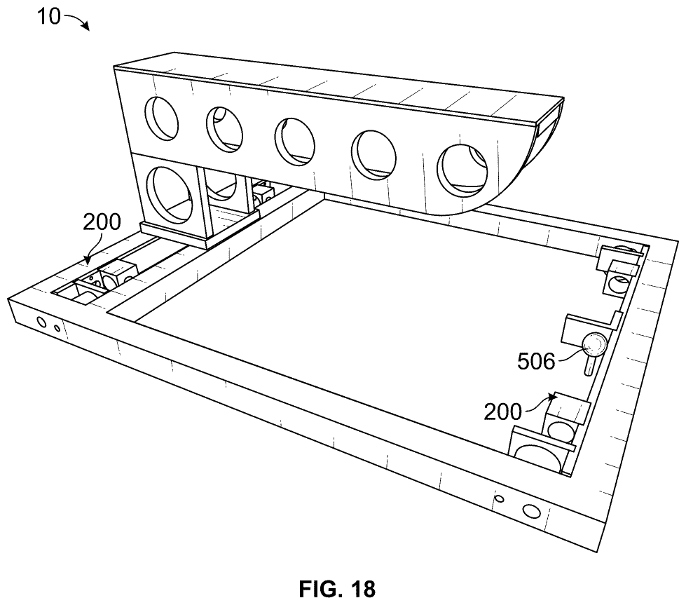

As shown in FIGS. 1 and 18 and detailed in FIG. 19, the registration system 200 may be coupled to the base frame 100. The registration system 200 comprises a registration spine 202, a registration alignment feature set 204, transport wheels 206, hold down blocks 208, and a registration guide 210. The registration alignment feature set 204 may include but is not limited to an alignment slot and/or bores/bosses for leveling set screws. The transport wheels 206 may be coupled to the registration spine 202 to allow for manual, semi-automatic, or fully automatic propulsion of the substrate cart 10 along an X-Y plane. The transport wheels 206 may be coupled to an electronic control system configured to power the propulsion and steering of the transport wheels 206. In some aspects, the electronic control system is preprogramed with XYZ operation directions, in other aspects, the electronic control system is remotely controlled. The hold down blocks 208 can either be pulled or pushed down by; magnetic actuators, pneumatic cylinders, electro-mechanical devices or other methods. The registration guide 210 in some aspects may be an “L-Flat” style guide comprising a rigid material as described in this specification. The registration guide 210 is configured to engage with a registration sphere 506 of an external station to locate and make positive contact with a perpendicular surface. In additional aspects, the registration guide may comprise “L-flat” surface normal to the both the spine 202 such that the registration sphere 506 can make a contact with a third surface to control the alignment height on the Z-Axis. In other aspects, the registration guide 210 or the registration spine 202 may comprise additional location detection sensors to determine when the registration guide 210 or registration spine 202 make contact with the registration sphere 506. The sensors may include but are not limited to proximity sensors, optical sensors, or force sensors. These sensors may be communicatively coupled to each manufacturing process station or remotely to a cloud system to be monitored. One of skill in the art would recognize that the registration system 200 may comprise a variable amount of the components described to engage with external aspects of the system or to engage in proper movement of the substrate cart 10.

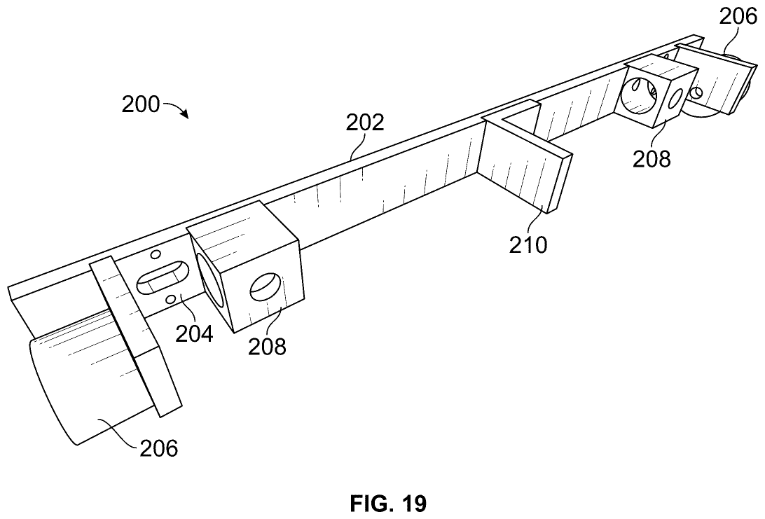

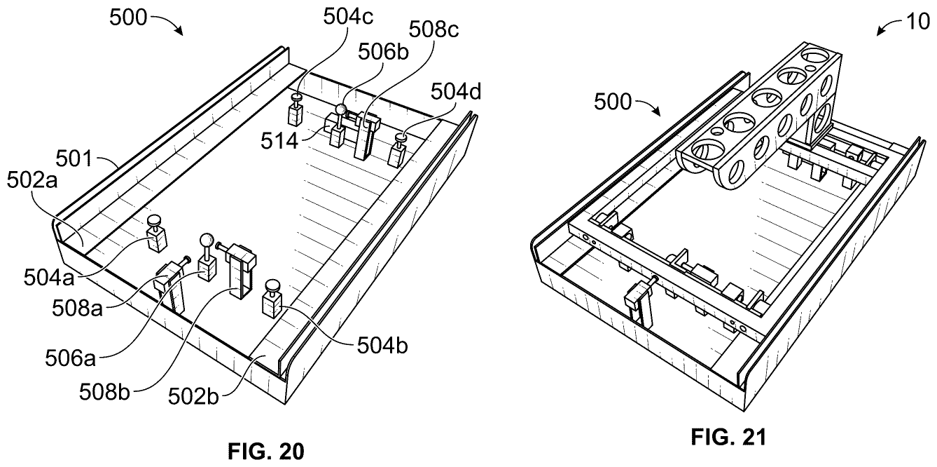

FIGS. 20 represents an example registration docking station 500 (referred to herein as registration dock or dock) configured to couple and precisely align to the registration system 200 of the substrate cart 10 to an external manufacturing process station. As shown in FIG. 20, the docking station 500 comprises a docking station body 501 having a pair of rails 502 (502a, 502b) disposed on opposite sides of the docking station body 501 configured to engage the registration system transport wheels 206, hold down members 504 coupled to the docking station body 501 configured to engage the registration system hold down blocks 208, registration spheres 506 coupled to the docking station body 501 configured to engage and make contact with the registration system registration guide 210, and nudge locators 508 coupled to the docking station body 501 to ensure the registration spheres make proper contact with the registration system registration guide 210. The hold down members 504 may be actuated by air, magnetic device, motor, or any other common actuation method. In some instances the registration docking station 500 additionally comprises a registration dock unique identifier 514. Similar to the cart unique identifier 126, the registration dock unique identifier 514 may include but is not limited to a sticker, a tag, an etching in the form of a serial number, barcode or QR code, or an RFID or NFC tag, or wireless communication device such as but not limited to cellular, Bluetooth, Wi-Fi, Lora, or Ultra Wide Band (UWB) transmitter. The registration dock unique identifier 514 may be correlated with a tracking or information database such that it can be identified throughout the factory or XYZ process.

In the example represented FIG. 20 the docking station 500 has a rectangular body 501 configured to accommodate a rectangular substrate cart 10. The rectangular body 501 having a front end 512 configured to accommodate the substrate cart 10 base frame 100 front member 104 and a rear end 514 configured to accommodate the substrate cart 10 base frame 100 rear member 106. The docking station comprises a first nudge locator 508a coupled to the docking station body 501 disposed centrally at the front end 512 configured to nudge normal to the front end 512. The docking station comprises a second nudge locator 508b coupled to the docking station body 501 disposed proximal the front end 512, distal the first nudge locator 508a configured to nudge parallel to the front end 512. Further docking station comprises a first registration sphere 506a coupled to the docking station body proximal the front end 512, adjacent to the second nudge locator 508b. Additionally the docking station 500 comprises a first hold down member 504a adjacent to and aligned to the first registration sphere 506a and a second hold down member 504b adjacent to the second nudge locator 508b. Proximal the rear end 514, the docking station comprises a third nudge locator 508c coupled to the docking station body 501 configured to nudge parallel to the front end 512. Further docking station comprises a second registration sphere 506b coupled to the docking station body 501 adjacent to the second nudge locator 508b. Additionally the docking station 500 comprises a third hold down member 504c adjacent to and aligned to the second registration sphere 506b and a fourth hold down member 504d adjacent to the third nudge locator 508c. One of skill in the art would recognize that the exact positioning and number of the docking station components as listed above may vary depending on the industrial application. For example the front and rear side may require additional hold down members 504 or the position may be moved to accommodate a substrate cart 10 having increased or differently placed inner members 118.

One of skill in the art would recognize that the registration sphere 506 is configured to make multipoint contact with the registration system 200 to ensure proper alignment and registration of the substrate cart 10 with the registration docking station 500. The geometry of a sphere lends itself to making contact both to the registration spine 202 and the normal extending registration guide 210. One of skill in the art would recognize that the “sphere” may indeed be a partial sphere or another geometric shape serving the similar purpose of making contact to surfaces normal to each other.

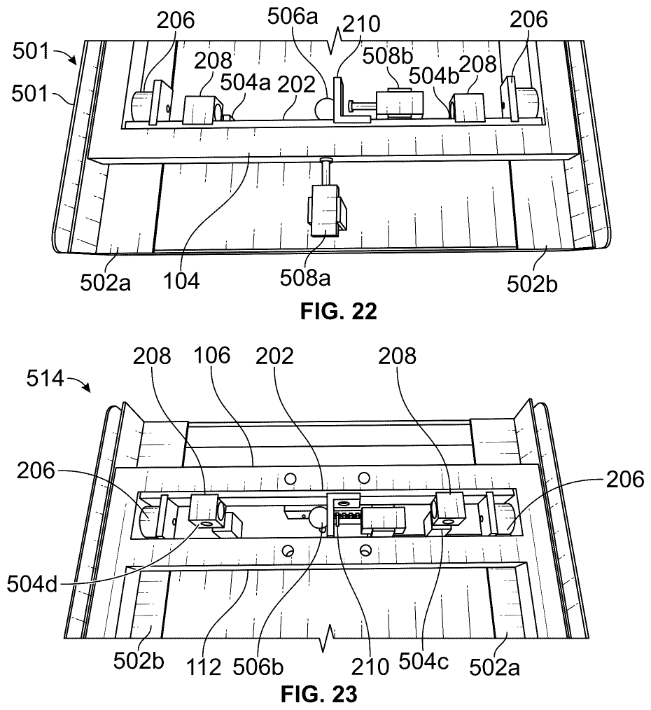

FIGS. 21-23 represent a substrate cart 10 engaged with a registration docking station 500. As shown in FIG. 22, representing the front of the substrate cart 10 and front end of the registration docking station 500, the transport wheels 206 are engaged with the registration docking station rails 502a, 502b allowing the substrate cart 10 to move back and along the direction of the rails for alignment. The front member 104 may engage a first nudge locator 508a to ensure proper Y-Axis positioning, the first registration sphere 506a makes contact with the with the registration guide 210 to ensure proper X-Axis positioning. If the first registration sphere 506a is not in proper X-Axis positioning, the second nudge locator 508b may be used to bias the cart 10 in the X-Axis to make contact between the registration guide 210 and the registration sphere 506a. When aligned, the hold down members 504a, 504b are actuated and raised into the hold down blocks 208 to lock the substrate cart 10 into the alignment. Similarly, As shown in FIG. 23, representing the rear of the substrate cart 10 and rear end 514, the transport wheels 206 are engaged with the registration docking station rails 502a, 502b allowing the substrate cart 10 to move back and along the direction of the rails for alignment. The inner member 112 and rear member 106 act as y-direction alignment constraints confining the registration docking station rear alignment features there between. The second registration sphere 506b makes contact with the with the registration guide 210 to ensure proper X-Axis positioning. If the registration sphere is not in proper X-Axis positioning, the third nudge locator 508c may be used to bias the substrate cart 10 in the X-Axis to make contact between the registration guide 210 and the second registration sphere 506b. When aligned, the hold down members 504c, 504d are actuated and raised into the hold down blocks 208 to lock the substrate cart 10 into the alignment. The registration sphere 506a, 506b may in some cases align and make contact with the registration guide 210 to ensure proper X-Axis alignment, and in some cases may align and make contact with the registration spine 202 to ensure proper Y-Axis alignment. In other aspects, the registration sphere 506 may comprise additional location detection sensors to determine when the registration guide 210 or registration spine 202 make contact with the registration sphere 506. The sensors may include but are not limited to proximity sensors, optical sensors, or force sensors. These sensors may be communicatively coupled to each manufacturing process station or remotely to a cloud system to be monitored.

A method of engaging the substrate cart 10 with the registration docking station 500 may include the steps aligning the registration transport wheels 206 to the registration docking rails 502a, 502b, rolling the substrate cart 10 onto the registration docking rails 502a, 502b until the front member until the registration spine 202 makes contact with a first registration sphere 506a in the Y-axis and the registration guide makes contact with the first registration sphere 506b in the X-axis direction and the second registration guide 210 makes contact with the second registration sphere 506b in the X-axis direction and the second registration spine 202 in the Y-axis direction, activating the hold down blocks 208 and hold down members 504 (504a-504d) to engage and lock the substrate cart 10 into place.

Another method of engaging the substrate cart 10 with the registration docking station 500 may include the steps aligning the registration transport wheels 206 to the registration docking rails 502a, 502b, rolling the substrate cart 10 onto the registration docking rails 502a, 502b until the front member contacts the first nudge locator 508a, activating the first nudge locator 508a to nudge the front member 104 such the registration spine 202 makes contact with the first registration sphere 506a, activating the second nudge locator 508b to nudge the registration guide and substrate cart 10 in a horizontal direction such the registration guide 210 makes contact with the first registration sphere 506a, activating the third nudge locator 508c to nudge the second registration guide 210 and substrate cart 10 in a horizontal direction such the second registration guide 210 makes contact with the second registration sphere 506b, activating the hold down blocks 208 and hold down members 504 (504a-504d) to engage and lock the substrate cart 10 into place.

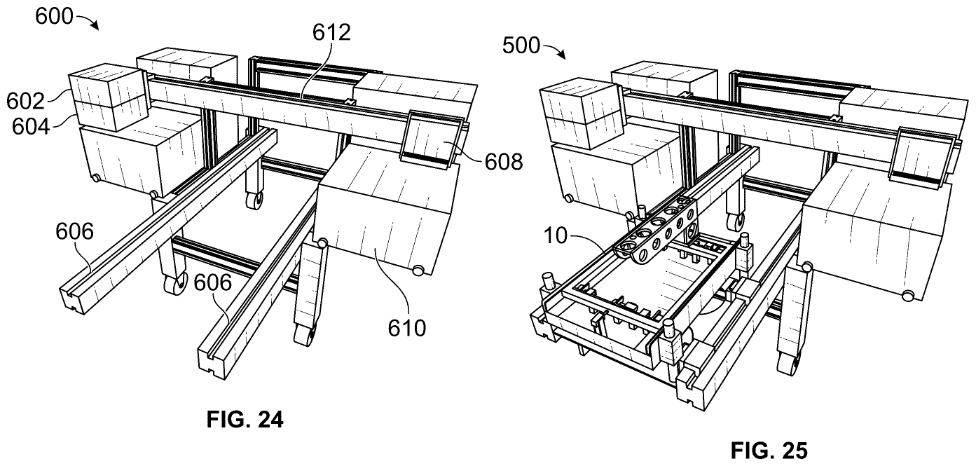

FIGS. 24-25 represent an example decorating station 600 configured to accommodate a registration dock 500 and a mounted substrate cart 10 and height adjustment system 700. FIG. 24 shows the decorating station 600 without the registration dock 500 and a mounted substrate cart 10. The decorating station 600 comprises a support unit 602 housing all sub-tanks and support circuitry, a delivery unit 604 that houses delivery components such as digital print heads or additional decorating heads as described above, a delivery rail 606 that transports the support unit 602 and delivery unit 604 over a work piece, a registration location system 608 to ensure registration of the dock 500 and substrate cart 10, optional cabinetry 610 for additional support components, and feed rails 612 to feed in the dock 500 and substrate cart 10 assembly. The feed rails 612 can be encoded and servo powered. FIG. 25 shows the dock 500 and substrate cart 10 assembly engaged on the feed rails 612 to be fed towards the decorating station delivery rail 606.

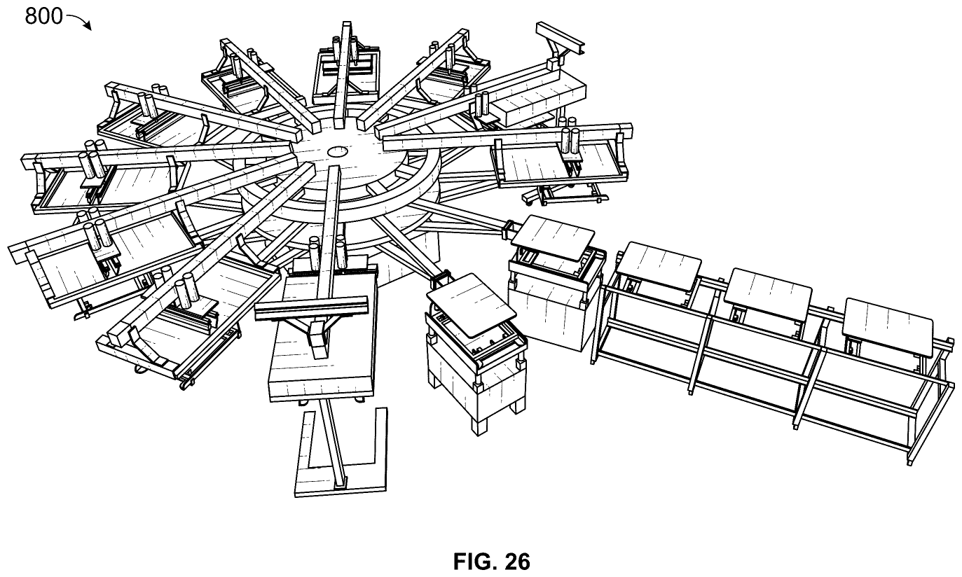

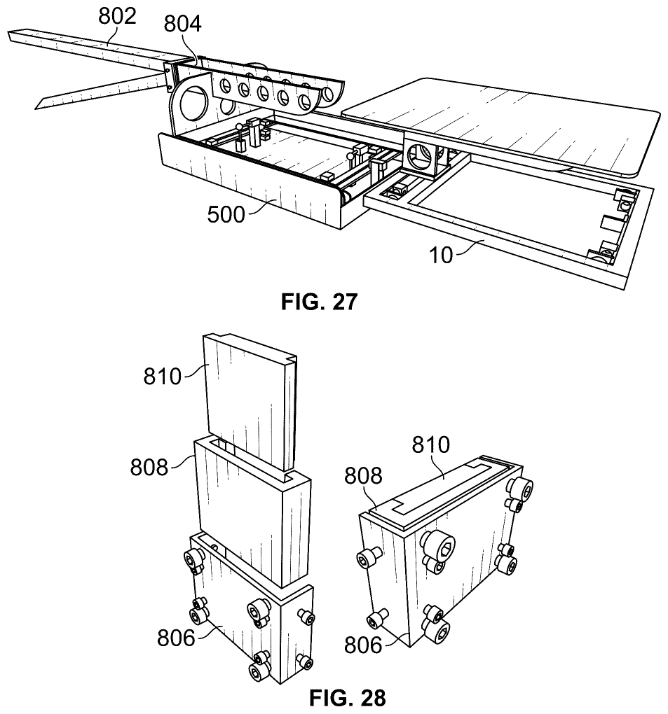

FIGS. 26-28. Represent another example decoration station 800 as commonly used in screen printing. In this example, as shown in FIGS. 26 and 27, each substrate cart 10 comprises a pallet cradle 134 coupled to the base frame 100, further each pallet cradle, while being processed by the decoration station 800 is coupled to a precision pallet arm 802 through a pallet arm precision connector 804. FIG. 28 shows the construction of a the pallet arm precision connector 804 as comprising a pallet arm bracket 806 fixed to the pallet arm 802, a pallet arm block 808 configured to engage with the pallet arm bracket 806 and pallet arm fixture slide 810, the pallet arm fixture slide 810 further coupled to the pallet cradle 134. A plurality of set screws 812 is shown to make adjustment to properly fit the assembly as shown.

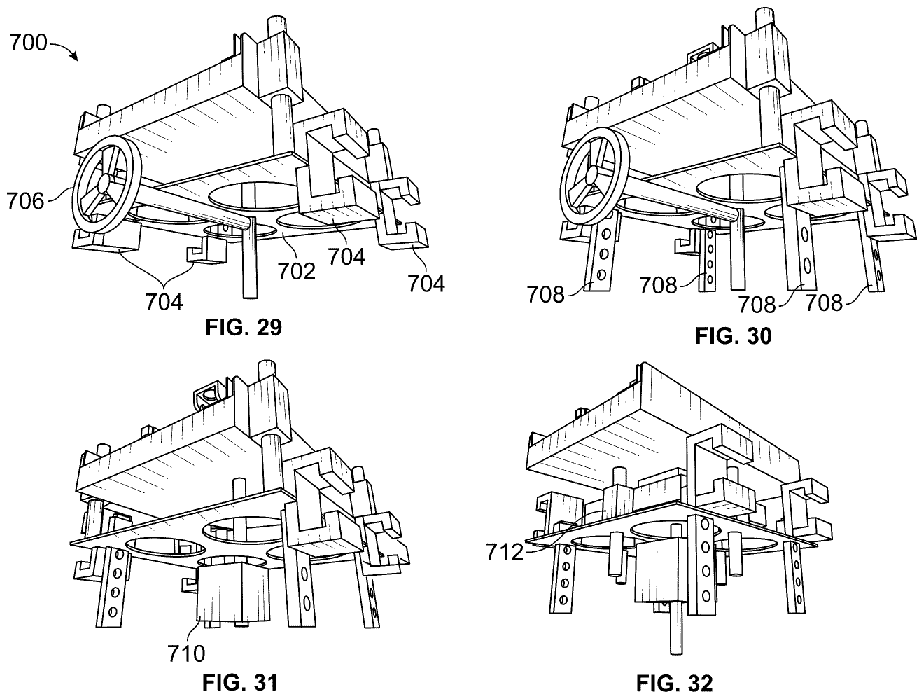

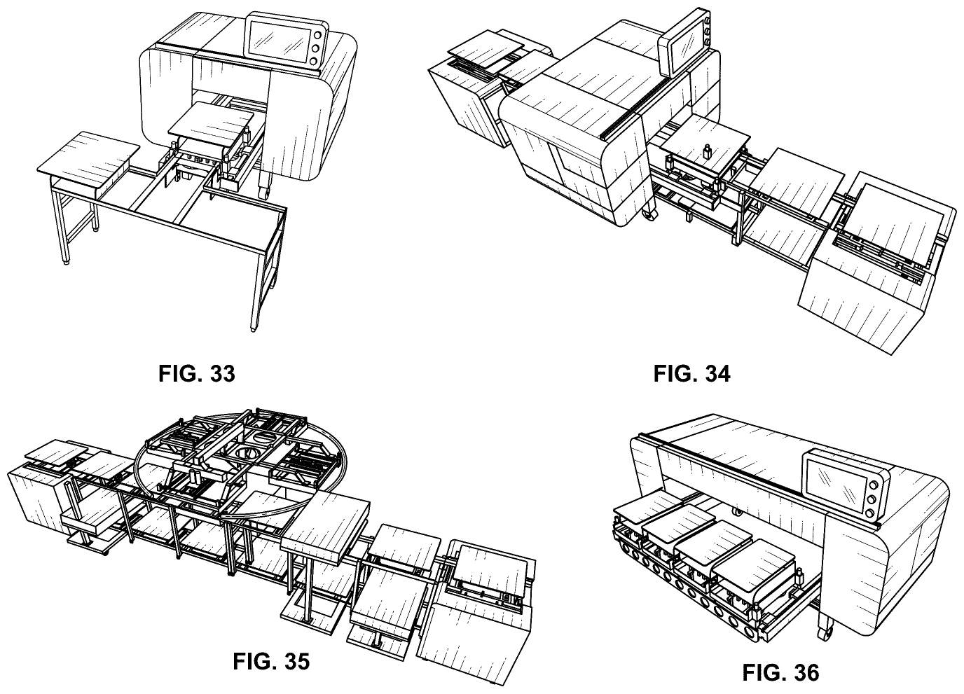

FIGS. 29-33 represent a height adjustment system 700 configured to couple to a registration dock 500 and mount to a decorating system 600 and raise and lower the dock 500 and substrate cart 10 assembly. As shown in FIG. 29, the height adjustment system 700 comprises an adjustment support plate 702, a plurality of rail fittings 704 coupled to the support plate 702 configured to engage feed rails 612, a plurality of guide members coupled to the dock 500 configured to allow Z-Axis translation in a first state, and a fixed Z-Axis position in a second state, and an adjustment wheel 706 coupled to the dock 500 configured to raise and lower the dock 500 upon turning the wheel 706. FIGS. 30-33 show additional embodiments of the height adjuster system such as manual raise-lower supports 708, a height adjusting servo 710 instead of the wheel 706 for automated adjusting, or adjustable gimbals 712 allowing for the decoration of curved or uneven surfaces. In some aspects the height adjuster system is communicatively coupled with a manufacturing process station and adjusts the height based on either preprogrammed heights for the particular manufacturing process station or comprises location sensors configured to alert the system to align to a particular height. The sensors may include but are not limited to proximity sensors, optical sensors, or force sensors. These sensors may be communicatively coupled to each manufacturing process station or remotely to a cloud system to be monitored.

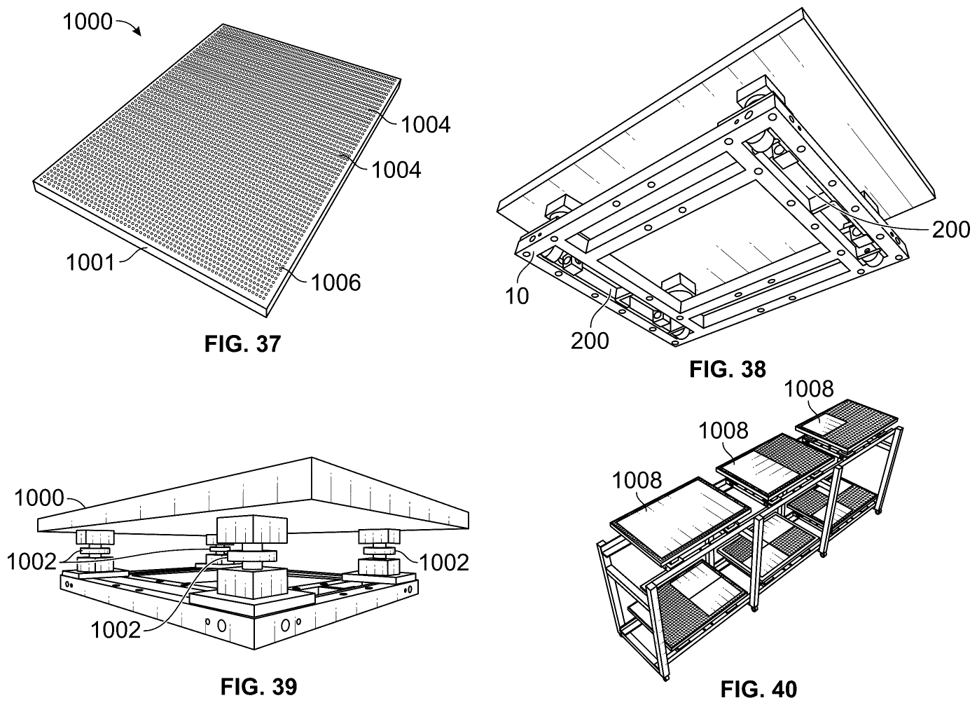

FIGS. 34-37 represent additional practical applications of registration dock 500 and a mounted substrate cart 10 and height adjustment system 700. FIG. 34 shows the assembly configured with t-loading allowing for less delay between loading and unloading of substrate carts 10. FIG. 35 shows an automatic inline system processing substrate carts 10 through an example decorating station. FIG. 36 shows multiple substrate carts 10 as being processed for screen printing wherein the screen with squeegee and flood bar ‘rig’ is rotated and the print head then inserts into the squeegee and flood bar and prints. the squeegee and flood bar move along linear rails with positive ‘push back pressure’. FIG. 37 shows multiple substrate carts 10 aligned horizontally to be decorated simultaneously.

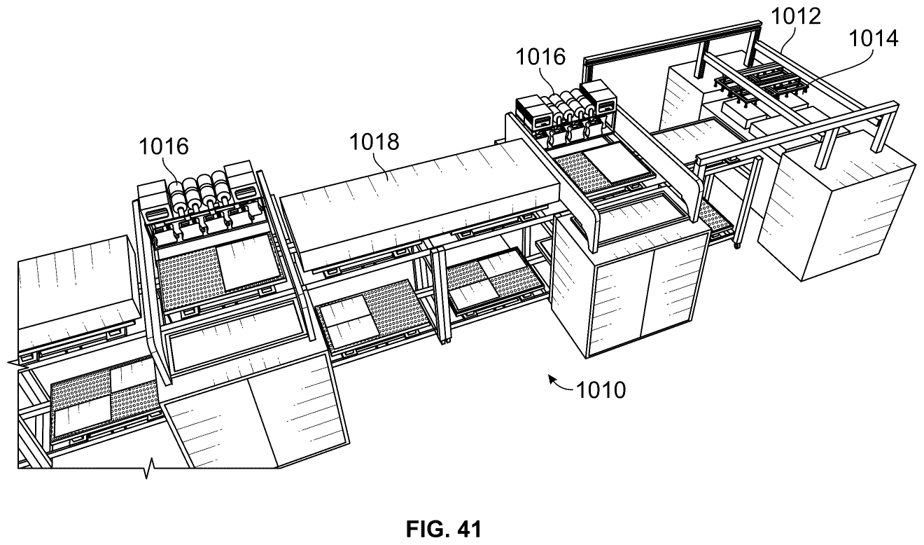

FIGS. 38-42 represent the use of the substrate cart 10 adapted as a vacuum table assembly 1000. In this application, a vacuum table top 1001 is coupled to the substrate cart 10 through a plurality of table top support members 1002. The table top support members 1002 may be fixed or adjustable in the Z-axis. Additionally, the table top support members 1002 may be automated to adjust height based communication of the vacuum table assembly 1000 with manufacturing process station or remotely adjusted. The vacuum table top 1001 comprises at least one vacuum suction opening 1004 coupled to a vacuum suction system (not shown) configured suction in the direction normal to the vacuum table top 1001. In some aspects, the vacuum table top 1001 comprises a plurality of vacuum suction openings 1004 configured into predefined zones. In this aspect, the vacuum suction system can be operated in each zone independently such that a first zone may have a vacuum force applied while the other zones do not. This can be accomplished with independent vacuum systems or a control system that seals off zones independently. In some aspects, the vacuum suction system is coupled directly to the substrate cart 10 and is battery powered, in other aspects, the vacuum suction system is coupled to the vacuum table assembly 1000 at the manufacturing process station. The vacuum suction system may be controlled as always on, or automated to turn off and with instructions from the manufacturing process station or remotely through a backend cloud system. The vacuum table top 1001 may comprise substrate alignment features 1006, to align the substrate 1008 to the vacuum table top 1000 prior to activating the vacuum suction system. In operation, a substrate 1008 is aligned to the vacuum table top 1001, the vacuum system is activated, and the substrate 1008 is secured to the vacuum table top 1001 through the vacuum system suction force. As shown in FIG. 41, multiple substrate carts 10 may be aligned for substrate 1008 decoration and removal. Additionally, as shown in FIG. 41, multiple size substrates 1008 may be used on the vacuum table top 1001. In some aspects, as further described below, the unique identifier 126 on each substrate cart 10 is used to determine the size and placement of the substrate 1008 on top of the vacuum table top 1001.

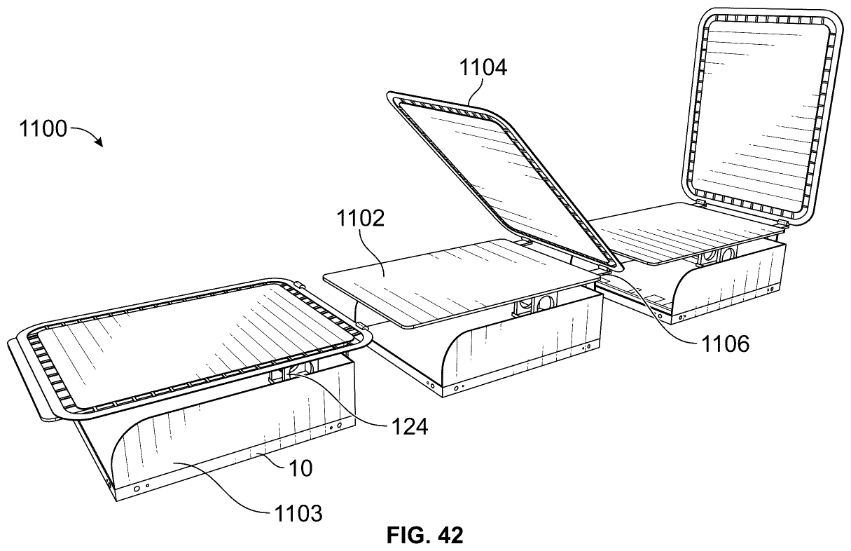

FIG. 42 shows an example application of the vacuum table assembly 1000 as used in a direct to film printing application. In a first aspect, the vacuum table assembly 1000 is placed on a decorating rack 1010 proximal a substrate loading station 1012. The substrate loading station 1012 may be a manual loading station or may be an automated station using picker members 1014 like suction cups, to pick up a particular sized substrate and place it onto the activated vacuum table assembly 1000. In some aspects, the substrate loading station 1012, reads the unique identifier 126 of the vacuum table assembly 1000 and picks the appropriate substrate 1008 based on preprogrammed instructions for the unique identifier 126. The decorating film substrate 1008 is vacuum suctioned to the vacuum table top 1001. The vacuum table assembly 1000 is transported through the transport wheels 206 to various stations in the decoration process. The substrate cart 10 may dock in registration dock 500 features for alignment at each process step. As shown, the substrate cart 10 moves through a printing stage 1016, a drying stage 1018, in some aspects a second printing stage 1016 depending on the number of layers that are needed to be printed and dried.

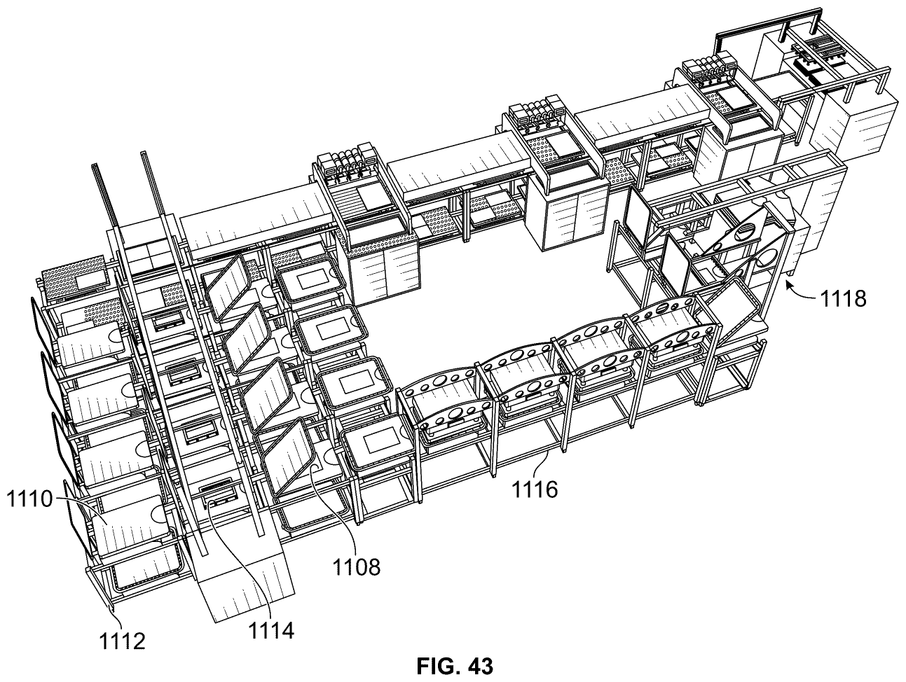

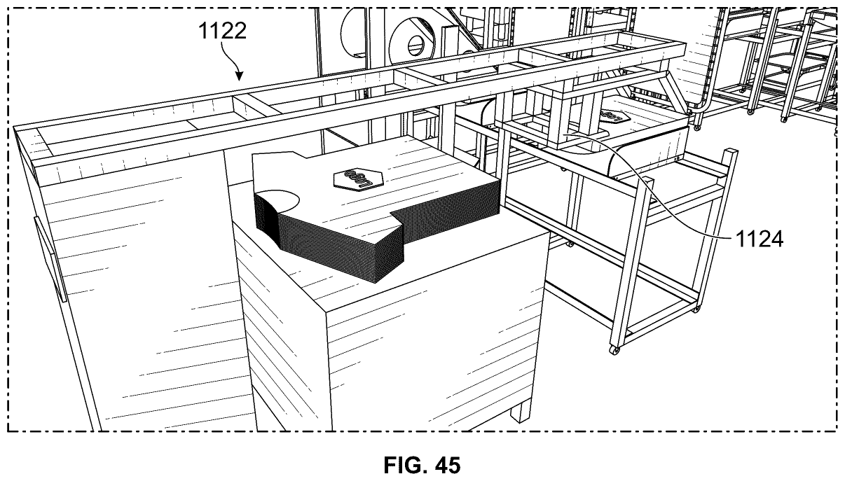

FIGS. 43-45 represent the use of the substrate cart 10 adapted as a to be used secure a garment substrate 1110 and transfer film 1108 in a DTF film transfer process. As shown in FIG. 43, the film transfer assembly 1100 comprises a substrate cart 10 having a support boom 124, a substrate support pallet 1102, a protection bin 1103, and a transfer film cover 1104 rotatably coupled through a hinge 1106 configured to cover and secure the transfer film 1108 to the garment substrate 1110 in a closed position. The hinge 1106 in some aspects may be preloaded to automatically close or automatically open depending on the printing application. The transfer film cover 1104 may comprise a thin material configured to transfer heat to the transfer film in a heat press operation. In some examples the thin material may be a piece of tensioned Teflon. The optional protection bin 1103 acts to store overflow areas of the garment 1110 such as extra material or long sleeves such that the extra material does not interfere with the decoration process.

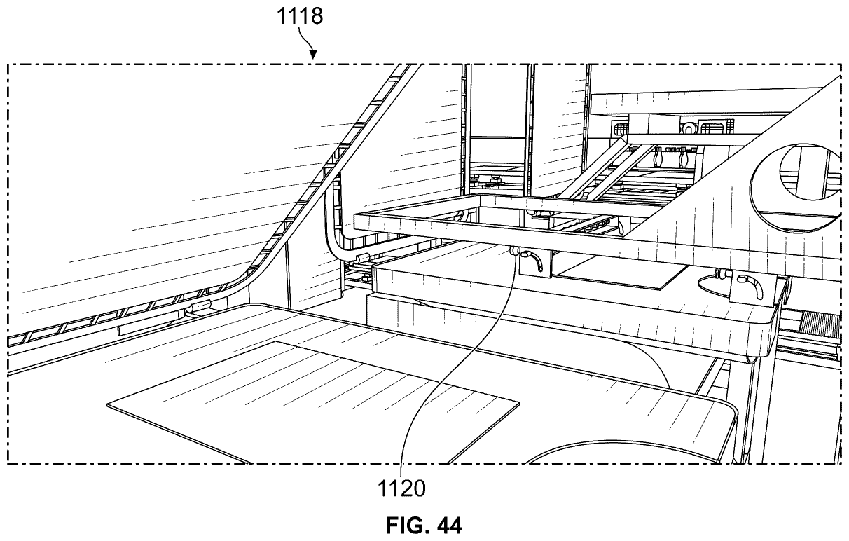

In operation, as shown in FIGS. 44-46, at least one film transfer assembly 1100 comprising a garment substrate 1110 is placed onto a heat transfer assembly rack 1112. The transfer film cover 1104 is rotated into an open position and a transfer film 1108 is placed onto the garment substrate 1110. The transfer film 1108 may be placed manually, or it may be an automated process using suction members 1114 or other picking devices to pick up the transfer film 1108 place it onto the garment substrate 1110. In some aspects, the system reads the unique identifier 126 of the film transfer assembly 1100 and picks the appropriate transfer film 1108 based on preprogrammed instructions for the unique identifier 126. Upon receipt of the transfer film 1108, the transfer film cover 1104 is rotated into a closed position securing the transfer film 1108 onto the garment substrate 1110. The transfer film assembly 1100 is traversed along the heat transfer assembly rack 1112 through the transfer wheels 206 of the cart registration system 200 until it reaches the heat press station 1116. The heat press station 1116 presses onto the transfer film cover 1104, transferring heat through the transfer film cover 1104 onto the transfer film 1108. The heat press action causes the transfer film 1108 to transfer its ink onto the garment substrate 1110. After the heat press operation is complete, the transfer film assembly 1100 is traversed to the film removal station 1118. At the film removal station 1118 the transfer film cover 1104 is rotated into an open position and the transfer film 1108 is removed from the garment substrate 1110. Removal can be done manually or it may be an automated process using suction members 1120 or other picking devices to pick up the transfer film 1108. At that point the film transfer assembly 1100 moves to a garment removal stage 1122 where an unloader arm 1124 removes the garment substrate 1110 from the film transfer assembly 1100. One of skill in the art would recognize that the system as shown in FIG. 42 may be integrated into the system shown in FIG. 44 as part of a running decoration line, or the systems may be separate.

In another aspect, the system comprises a backend cloud system comprising a database containing a manufacturing process station XYZ positional layout, the system communicatively coupled with each manufacturing process station and a plurality of substrate carts 10 and registration docks 500. In this aspect, each substrate cart 10 additionally communicates its position through a means of wireless communication to the backend cloud system and the backend cloud system is configured to send station instructions and directional instructions to the substrate cart 10 to control the transport wheels 206 or skid wheels to direct the substrate cart 10 to the next station.

Those of ordinary skill in the art will understand and appreciate the aforementioned description of the invention has been made with reference to a certain exemplary embodiment of the invention, which describe a substrate cart system, apparatuses, and methods of use. Those of skill in the art will understand that obvious variations in construction, material, dimensions or properties may be made without departing from the scope of the invention which is intended to be limited only by the claims appended hereto.

1. A substrate cart comprising:
a base frame having outer perimeter and an inner perimeter;
at least one adaptor position and locator feature disposed on the base frame outer perimeter; and
at least one registration system coupled to the base frame inner perimeter.

2. The substrate cart of claim 1 having an outer and inner perimeter formed by a front member, a rear member, and a pair of side members wherein at least a first registration system is coupled to an inner surface of the front member within the inner perimeter or to the an inner surface of the rear member within the inner perimeter.

3. The substrate cart of claim 2 having at least one inner member coupled between the pair of side members proximal the rear member, the inner member defining a first opening and a second opening.

4. The substrate cart of claim 2 wherein the at least first registration system system comprises:
a spine member;
a first transport wheel coupled to a proximal end of the spine member, a second transport wheel coupled to a distal end of the spine member;
a registration alignment feature set disposed in the spine member;
at least one hold down block coupled to the spine member; and
a registration guide coupled to the spine member.

5. The substrate cart of claim 4 wherein the registration guide comprises a a flat member extending normal to the spine member.

6. The substrate cart of claim 4 wherein the registration alignment feature set comprises at least one of an alignment slot or locator hole.

7. The substrate cart of claim 5 comprising a base frame connector adaptor having:
a base frame connector spine coupled to the base frame through the at least one adaptor position and locator feature; and
a coupling mechanism coupled to the base frame connector spine member.

8. The substrate cart of claim 7 wherein the coupling mechanism is coupled to a coupling mechanism of a base frame connector adaptor of a second substrate cart.

9. The substrate cart of claim 8 wherein the coupling mechanism is coupled to a coupling mechanism of a base frame connector adaptor of a second substrate cart through an articulating linkage.

10. The substrate cart of claim 4 having at least one boom member coupled to the rear member and the inner member.

11. The substrate cart of claim 10 further comprising a pallet member coupled to the at least one boom member configured to support a decoration substrate.

12. The substrate cart of claim 11 wherein the substrate cart is adapted for an embroidery application and the pallet comprises:
a support pad configured to support the decoration substrate;
an inner hoop configured to keep the decoration substrate tensioned;
an outer hoop coupled to the inner hoop configured to tension the decoration substrate;
a plunger disposed on a bottom side of the pallet, the plunger configured to eject the support pad; and
an ejector level and pivot mechanism configured to actuate the plunger.

13. The substrate cart of claim 11 wherein the substrate cart is adapted for decorating long pants as a substrate further comprising:
a long pants pallet fixture having a plurality of long pants pallet fixture support members coupled to the base frame through a plurality of adaptor and location members, further long pants pallet fixture comprising a plurality of hold down members; and
a long pants pallet split into two planks each having a hold down feature configured to engage and couple to the plurality of hold down members.

14. The substrate cart of claim 4 further comprising a pair of protective skids coupled to the base frame through a plurality of adaptor and locator features, the protective skids extending below the transport wheels.

15. The substrate cart of claim 4 comprising a pair of base frame transport wheel adaptors, the base frame transport wheel adaptors each comprising a base frame transport wheel at a distal and proximal ends of the base frame transport wheel adaptors, further wherein each wheel of the base frame transport wheel adaptors descends below the registration system transport wheels.

16. The substrate cart of claim 15 wherein the base frame transport wheels are configured to swivel or the are configured with a grooved surface to accommodate a cable guide.

17. The substrate cart of claim 15 wherein the base frame transport wheels are coupled to a manual or automated braking or propulsion system.

18. The substrate cart of claim 2 having a first inner member coupled between the pair of side members proximal the rear member, a second inner member coupled between the pair of side members proximal the front member, a third inner member coupled between the first inner member and the second inner member proximal a second side member of the pair of side members.

19. The substrate cart system of claim 2 having a unique identifier coupled to the base frame.

20.-45. (canceled)
